(19) United States
(12) Patent Application Publication
(10) Pub. No.: US 2007/0264003 A1
(43) Pub. Date: Nov. 15, 2007

(54) Post Capture Image Quality Assessment

(75) Inventor: German Voronov, Holon (IL)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: TransChip, Inc., Ramat-Gan (IL)

(21) Appl. No.: 11/674,719

(22) Filed: Feb. 14, 2007

Related U.S. Application Data
(60) Provisional application No. 60/773,400, filed on Feb. 14, 2006.

(51) Int. Cl. G03B 17/18

(52) U.S. Cl. 396/281

(57) ABSTRACT

An image capture device includes an image capture medium configured to record image data representative of a scene, a lens, positioned to focus an image of the scene onto the image capture medium, an input configured to receive a user-command to capture the image, an output configured to alert a user to the presence of an image artifact in the captured image, and a processor. The processor is programmed to receive at least a portion of the image data from the capture medium, analyze the image data for the presence of the image artifacts, and, based on the analysis send alert information to the output.

### CROSS-REFERENCES TO RELATED APPLICATIONS

This application is a non-provisional, and claims the benefit, of co-pending, commonly assigned, U.S. Provisional Application No. 60/773,400, filed on Feb. 14, 2006, entitled “POST CAPTURE IMAGE QUALITY ASSESSMENT,” the entirety of which is herein incorporated by reference for all purposes.

This application is related to the following co-pending, commonly-assigned U.S. patent applications, the entirety of each of which being herein incorporated by reference for all purposes: U.S. patent application Ser. No. 10/474,798, filed Oct. 8, 2003, entitled “CMOS IMAGER FOR CELLULAR APPLICATIONS AND METHODS OF USING SUCH”; U.S. patent application Ser. No. 10/474,275, filed Feb. 11, 2005, entitled “CMOS IMAGER FOR CELLULAR APPLICATIONS AND METHODS OF USING SUCH”; U.S. patent application Ser. No. 10/474,799, filed Oct. 8, 2003, entitled “BUILT-IN SELF TEST FOR A CMOS IMAGER”; U.S. patent application Ser. No. 10/333,942, filed Apr. 29, 2003, entitled “SINGLE CHIP CMOS IMAGE SENSOR SYSTEM WITH VIDEO COMPRESSION”; U.S. patent application Ser. No. 11/101,195, filed Apr. 6, 2005, entitled “METHODS AND SYSTEMS FOR ANTI SHADING CORRECTION IN IMAGE SENSORS”; U.S. patent Application Ser. No. 11/107,387, filed Apr. 14, 2005, entitled “SYSTEMS AND METHODS FOR CORRECTING GREEN DISPARITY IN IMAGER SENSORS”; U.S. patent application Ser. No. 11/223,758, filed Sep. 9, 2005, entitled “IMAGE FLICKER COMPENSATION SYSTEM AND METHOD,” which is a non-provisional, and claims the benefit, of U.S. Provisional Application No. 60/609,195, filed Sep. 9, 2004, entitled “IMAGER FLICKER COMPENSATION”; and U.S. patent application Ser. No. 11/467,044, filed Aug. 24, 2006, entitled “SMEAR CORRECTION IN A DIGITAL CAMERA,” which is a non-provisional, and claims the benefit, of U.S. Provisional Application No. 60/711,156, filed Aug. 24, 2005, entitled “METHODS AND APPARATUS FOR SMEAR CORRECTION IN A DIGITAL CAMERA.”

### FIELD OF THE INVENTION

Embodiments of the present invention relate generally to image capture. More specifically, embodiments of the invention relate to systems and methods for assessing the quality of a captured image.

### BACKGROUND OF THE INVENTION

The image capture process in most imaging solutions, such as digital still cameras (DSC), camera-enabled mobile phones, camera-enabled cordless phones (cameraphone), and the like, generally includes the following stages: 1) view finding, wherein the user observes the preview display, such as a small LCD, and points the camera toward the scene to be captured; 2) capture, wherein the user presses a capture button to capture the scene selected during view finding. At this point, the camera may change its operating conditions to produce an optimal picture. Such may include changing exposure duration, gains, color correction parameters, and/or the like; and 3) capture preview, wherein the captured image may be viewed on the preview display. The user observes the picture and decides if the image is acceptable. If the image is not acceptable, the user may choose to recapture the scene.

In many instances, it is difficult to detect degradations in image quality on a small preview display. Without an indication of possible image quality degradation, a user may not discover that the picture is degraded or obsolete until the image is printed or rendered on a larger display, for example, after downloading the image to a PC. This is particularly disadvantageous since reproducing the exact same scene to take another picture may be impossible.

### BRIEF SUMMARY OF THE INVENTION

Embodiments of the invention provide an image capture device. The image capture device includes an image capture medium, configured to record image data representative of a scene, a lens, positioned to focus an image of the scene onto the image capture medium, an input configured to receive a user-command to capture the image, circuitry configured receive and analyze at least a portion of the image data, and an output configured to alert a user to the presence of an image artifact in the image data in response to the analysis by the circuitry. The artifact may be smear, noise, degraded focus, degraded color or brightness, and/or the like. The output may be configured to provide an alert to the user of the type of artifact. The output may be configured to provide a suggested corrective measure to the user.

Other embodiments provide a method of capturing an image of a scene with an image capture device. The method includes receiving a user-initiated command to capture the image, capturing the image of the scene, in response to the user-initiated command to capture the image, analyzing the captured image for image artifacts, and upon detection of an image artifact in the captured image, providing an alert to a user. The artifact may be smear, noise, degraded focus, degraded color or brightness, and/or the like. Providing an alert to a user may include providing an alert to the user of the type of artifact and/or providing a suggested corrective measure.

Still other embodiments provide an image capture device. The device includes an image capture medium configured to record image data representative of a scene, a lens, positioned to focus an image of the scene onto the image capture medium, an input configured to receive a user-command to capture the image, an output configured to alert a user to the presence of an image artifact in the captured image, and a processor. The processor is programmed to receive at least a portion of the image data from the capture medium, analyze the image data for the presence of the image artifacts, and, based on the analysis send alert information to the output. The processor may be programmed to receive information from local contrast measurement circuitry and use the information to analyze the image data for the presence of image artifacts. The processor may be programmed to receive motion estimation information from motion estimation circuitry and use the motion estimation information to analyze the image data for the presence of image artifacts. The image data may be first image data and the processor may be programmed to receive second image data from a contemporaneously captured image and use the second image data to analyze the first image data for the presence of image artifacts. The processor may be further programmed to determine whether automatic focused reached convergence at image capture and use the determination to analyze the image data for the presence of image artifacts. The processor may be programmed to determine whether an automatic algorithm reached convergence at image capture and use the determination to analyze the image data for the presence of image artifacts.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an exemplary image capture device according to embodiments of the invention.

FIG. 2 depicts an exemplary method of assessing image quality according to embodiments of the invention, which method may be implemented in the device of FIG. 1.

FIG. 3 depicts a decision flow for smear detection by local contrast according to embodiments of the invention.

FIG. 4 depicts a decision flow for detection by global estimation according to embodiments of the invention.

### DETAILED DESCRIPTION OF THE INVENTION

Embodiments of the present invention relate to capturing images. In order to provide a context for describing embodiments of the present invention, embodiments of the invention will be described herein with reference to digital image capture. Those skilled in the art will appreciate, however, that other embodiments are possible. For example, embodiments of the invention may be used to capture images to film.

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It is to be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, systems may be shown in block diagrams in order not to obscure the embodiments in unnecessary detail. In other instances, well-known processes, structures and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

According to embodiments of the invention, an image capture device detects potential image quality degradation and provides an indication to a user that a captured image may be of degraded quality. This can be done before, during, or after image capture. Some embodiments provide arrangements that measure image quality degradation, arrangements that analyze image quality degradation, and/or arrangements that notify a user of potential quality degradation.

Image quality degradations may include: 1) smear, wherein an image is blurred due to camera movement during image exposure. This is a very common artifact that usually appears when a camera is hand held during capture. It also may occur as a result of an object moving in a captured scene; 2) noise. When photographing in low illumination conditions without auxiliary lighting (e.g., Flash LED, Flash, etc.), gains may need to be increased in order to achieve an image having a proper brightness level. High gains lead to amplification of noise, possibly to unacceptable levels; 3) degraded colors or brightness, which may result when camera parameters are not properly set for the scene being captured; 4) improper focus, which may result when an automatic focus function is not properly set for a scene, and/or the convergence confidence is low; and/or 4) other. Other parameters, unrelated to color and brightness, such as flicker compensation, dynamic noise reduction, and the like, may not be properly set or may not have completed adaptation for a particular scene at the time of image capture.

If a user is aware that a captured image may be distorted, the user may chose to capture another image. Moreover, if the particular type of distortion is known, the user can modify the capture conditions in an effort to reduce the associated effect. If smear is present, the user may: a) physically support the camera, such as hold it with two hands or place hand on a fixed surface (e.g., a table); b) disable night mode, if night mode is active; and/or c) apply “sport” mode to decrease exposure duration to capture fast changing scenes. If noise is present, the user may: a) activate night mode; b) activate flash; and/or c) improve lighting conditions. IF degraded focus is present, the user may: a) take another image, allowing automatic focus to complete convergence; and/or b) take a slightly different picture to allow automatic focus more scene content for better convergence. If degraded colors or brightness is present, the user may: a) take another image, allowing automatic algorithms to complete convergence; and/or b) take a slightly different picture, allowing automatic algorithms to select better capture parameters. If other degradations are present, the user may: a) take another image, allowing automatic algorithms to complete their convergence.

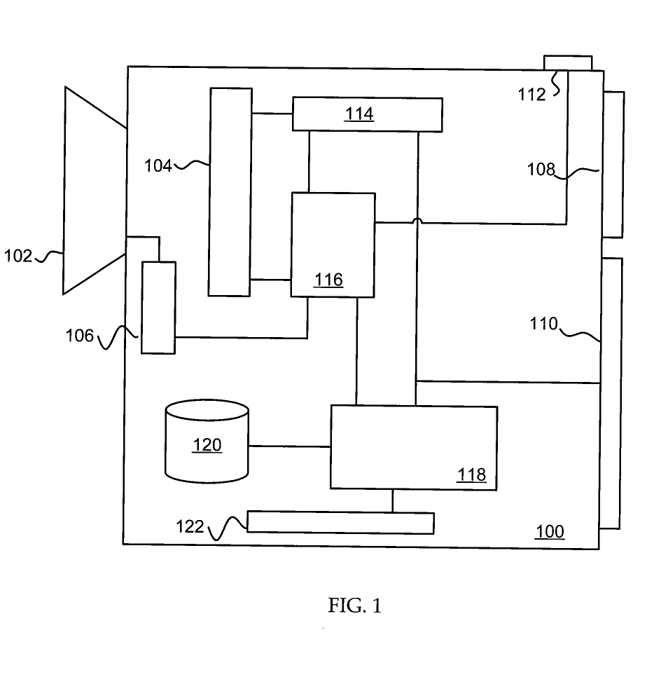

Having described embodiments of the invention generally, attention is directed to FIG. 1, which depicts an exemplary image capture device 100 according to embodiments of the invention. The image capture device 100 is a digital still camera. Those skilled in the art will appreciate, however, that other image capture devices according to other exemplary embodiments may be film cameras, digital movie cameras, camera-enabled mobile phones, and the like. The camera 100 includes a lens 102 that focuses an image onto a capture medium 104. In this example, the capture medium 104 comprises an array of complementary metal-oxide-semiconductor (CMOS) pixels, although in other embodiments the capture medium may be film, photodiodes, CCD sensors, or the like. Prior to image capture, the image capture device may sense conditions (e.g., lighting, focal distance, etc.) and/or adjust capture parameters. For example, an auto-focus 106 may change the focal length of the lens based on the distance from the scene to the capture medium 104.

A user may view the scene through a viewfinder 108 and/or a preview screen 110. A shutter release button 112 allows the user to send a capture command to the device. The user also is able to preview the captured image on the preview screen 110.

Upon image capture, readout circuitry 114, under the control of a processor 116, reads image data from the capture medium 104. The image data may be sent to a preview buffer and displayed on a preview screen 110. In some embodiments, the image data is sent directly to removable media 120.

According to embodiments of the invention, the user may preview an image and choose to discard it. The user's decision may be aided by an alert that notifies the user to possible unwanted artifacts in the image. Such artifacts may include smear, noise, improper color and/or brightness, and/or the like. The alert may appear on the preview screen 110 and may include an indication of the type of artifact that is potentially present. In some embodiments, the alert provides the user with a suggested corrective measure.

The alert that notifies the user of possible unwanted artifacts is generated in response to analyses performed by the processor 116 or dedicated image assessment circuitry 118. According to embodiments of the invention, the processor 116 is programmed or otherwise configured to receive at least some of the image data from the recently-captured image as it is read from the capture medium 104. The processor 116 also may have access to image data from previously-captured images. The processor 116 also may have access to information regarding the condition of capture parameters (e.g., auto-focus 106) and/or other useful information (e.g., motion estimation 122). The processor 116 uses the information, as will be described hereinafter, to predict whether image artifacts are likely to exist in the captured image. If so, the processor 116 alerts the use accordingly.

As mentioned above, image assessment may be performed by an existing host processor, such as the processor 116, or may be performed by dedicated image assessment circuitry 118. If the function is performed by a host processor, then embodiments of the invention may be implemented in preexisting designs merely by adding appropriate code to program the processor, especially if the parameters for assessing the image quality are provided by pre-existing components (e.g., motion estimation 122). If, however, the image assessment function is performed by dedicated image assessment circuitry 118, then the circuitry (which may include hardware, firmware, software, and/or the like) may be designed from the outset to provide the desired functionality. In either case, the image assessment function may be performed on the fly, as image data is read from the capture medium 104.

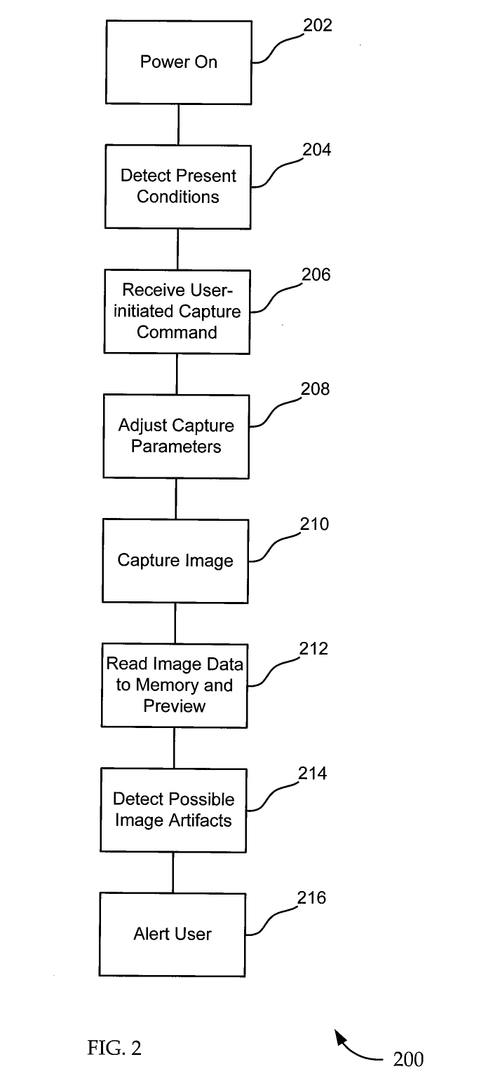

Having described an exemplary device according to embodiments of the invention, attention is directed to FIG. 2, which depicts an exemplary method 200 according to embodiments of the invention. The method may be implemented in the image capture device 100 of FIG. 1 or other appropriate device. Those skilled in the art will appreciate that the method 200 is merely exemplary of a number of possible method embodiments, some of which may have more, fewer, or different steps than those illustrated and described herein. Moreover, other exemplary methods according to other embodiments may traverse the steps in orders different than illustrated and described herein.

The method 200 begins at block 202 at which point the image capture device is powered on. At block 204, the device begins to acquire information relating to the current environmental conditions that may affect image quality. Examples include lighting intensity and frequency, distance to scene, etc. At block 206, the device receives a user-initiated command to capture an image. The device makes appropriate adjustments to capture parameters at block 208 and captures the image at block 210.

Once the image is captured, the image data is read from the capture medium. The image data may be read to a preview buffer or directly to removable media at block 212. At block 214, the host processor or dedicated image assessment circuitry detects image artifacts and alerts the user to the presence of image artifacts at block 216. Advantageously, this function may be performed “on the fly,” as the image data is being read from the capture medium.

According to embodiments of the invention, any or all of a number of operations may take place at block 214, several of which are discussed in greater detail immediately hereinafter. For example, the processor may receive input from local contrast measurement circuitry, motion estimation circuitry, and/or the like that assists the processor to detect artifacts. The processor may receive image information from one or more image frames captured contemporaneously with the subject frame, either before or after. The processor may receive information from other circuitry that indicates the point in time of image capture with respect to the point in time of image capture parameters having converged on a solution and that solution being implemented (e.g., focus, shutter speed, aperture, etc.). The processor then uses the information to determine whether image quality degradation exists.

In some cases, the presence of image quality degradation is not absolute. The measure of quality degradation may exist along a spectrum, and whether that measure exceeds a threshold determines the presence degradation. In such cases, the threshold may be user adjustable.

Those skilled in the art will appreciate how the ensuing examples for detecting specific types of image quality degradation may be implemented at block 214.

Detecting Smear

Smear in a captured image may be detected by various methods, two of which are described herein. In a first embodiment, smear is detected using local contrast measurement circuitry. Advantageously, such circuitry may be present in the image capture device for the purpose of automatic focusing.

According to this embodiment, most any circuitry that provides information related to local contrast may be used. In order to estimate the presence of smear artifact(s), one should assess an approximated value for actual local contrast measure that corresponds to the scene being captured. This can be accomplished by analyzing one or more frames just before image capture initiation. The highest obtained value of local contrast measure can be used as an estimation of actual local contrast measure that corresponds to the scene being captured. The value of local contrast measure corresponding to the captured frame is also obtained.

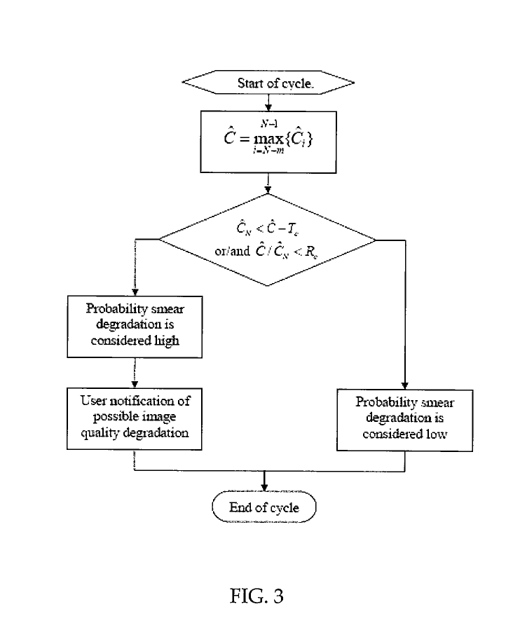

If the value of local contrast measure is below some threshold evaluated based on the estimation of actual local contrast measure that corresponds to the scene being captured, then the probability of image quality degradation as a result of smear is considered high and user should be notified. This method of detecting smear is depicted in the decision flow chart 300 of FIG. 3. Specifically, if:
C is the actual local contrast measure that corresponds to the scene being captured;
Ĉ is the estimation of actual local contrast measure that corresponds to the scene being captured;
Ĉₙ is the estimation of actual local contrast measure that corresponds to frame with index n;
m is the number of frames used for estimation of actual local contrast measure that corresponds to the scene being captured;
N is the index of captured frame; and
T_{c}, R_{c} are pre-defined threshold values that may be fixed or be functions of some internal parameters,
   then the decision whether smear may be present is obtained as depicted in FIG. 3.

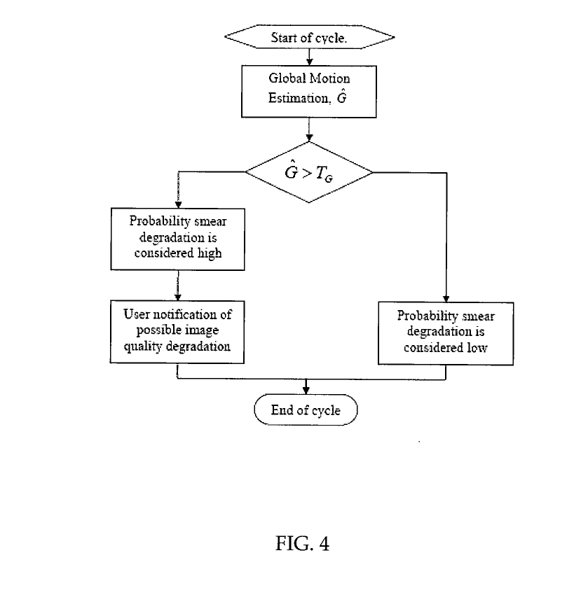

In another smear detection embodiment, motion detection or estimation circuitry is employed. Such circuitry may be present in devices that use video compression. In the absence of motion estimation circuitry, global motion estimation may be determined as described below. In either case, the result of global motion estimation is a vector describing the displacement of the captured image relative to a reference (previous) image in horizontal and vertical directions. To detect smear, the length of the global motion vector is analyzed. If its length exceeds certain predefine thresholds, then the probability of image quality degradation as a result of smear is considered high and the user should be notified. This method of detecting smear is depicted in the decision flow chart 400 of FIG. 4. Specifically, if:
Ĝ is the estimation of global motion between captured and previous frames; and
T_{G} is a predefined threshold value that may be fixed or be a function of some internal parameters, e.g. exposure duration,
   then the decision whether smear may be present is made as depicted in FIG. 4.

If no motion estimation capability is present, a simple, low complexity approach can be employed to estimate global motion.

Every frame is downsampled to produce a downsampled replica of the image (Replica). Downsampling by a factor of one or below is considered as a downsampling. Downsampling is performed either with or without employing anti-aliasing filtering. The downsampling ratio is selected to optimize: memory requirements and computation load of the system; ability for estimation of global motion that leads to noticeable smear artifacts. It may include optical specification of particular system and sensor performance; and other system parameters.

In order to estimate global motion the Replicas of captured frame and previous frames are analyzed. Global motion estimation can be obtained based on several mathematical approaches: calculation of correlation map between the two Replicas, either in spatial or frequency domains; calculation of error map; and/or other technique capable of motion estimation.

Since the global motion may be of sub-pixel accuracy in Replica domain, sub-pixel estimation may be required. Sub-pixel accuracy can be achieved by employing the following approaches or any other suitable approach: 1) correlation/error map is interpolated in the vicinity of optimal displacement (best correlation or smallest error). The location of the best match of the interpolated set is declared as the location of global motion. Global motion vector is then calculated based on this information; and/or 2) vicinity of the optimal displacement in the Replica domain is approximated by a smooth surface of order two or above, such that only one extreme exists in the interior of the support. Then the location of the extreme is declared as the location of global motion. Global motion vector is then calculated based on this information. After global motion vector is estimated, the presence of smear may be evaluated based on the procedure describe above.

Detecting Noise

Noise levels in a captured image can be estimated by analyzing parameters employed during capture. The ranges of various parameters that can potentially lead to high noise can be estimated off-line. Hence, either before, during, or after image capture, noise level is estimated. If the image capture parameters are in range of potentially high noise level, the user should be notified.

Detecting Degraded Focus

It may be determined that degraded focus artifact exists in the captured image if: automatic focus (AF) has not completed convergence prior picture capture; and/or automatic focus confidence is low. Automatic focus confidence can be estimated based on the features (richness) of the particular scene and ability of AF to converge to proper focus in these conditions. In either case, the user should be notified.

Degraded Color or Brightness or Other

Degraded color or brightness or other image artifacts may be determined to be present in the captured image if: any automatic algorithm has not completed convergence prior to image capture; and/or any or several internal parameters indicate that the captured image is potentially distorted in one way or another. In such cases, the user is notified.

Having described several embodiments, it will be recognized by those of skill in the art that various modifications, alternative constructions, and equivalents may be used without departing from the spirit and scope of the invention. Additionally, a number of well known processes and elements have not been described in order to avoid unnecessarily obscuring the present invention. Accordingly, the above description should not be taken as limiting the scope of the invention, which is defined in the following claims.

What is claimed is:

1. An image capture device, comprising:
an image capture medium, configured to record image data representative of a scene;
a lens, positioned to focus an image of the scene onto the image capture medium;
an input configured to receive a user-command to capture the image;
circuitry configured receive and analyze at least a portion of the image data; and
an output configured to alert a user to the presence of an image artifact in the image data in response to the analysis by the circuitry.

2. The device of claim 1, wherein the artifact comprises smear.

3. The device of claim 1, wherein the artifact comprises noise.

4. The device of claim 1, wherein the artifact comprises degraded focus.

5. The device of claim 1, wherein the artifact comprises degraded color or brightness.

6. The device of claim 1, wherein the output is further configured to provide an alert to the user of the type of artifact.

7. The device of claim 1, wherein the output is further configured to provide a suggested corrective measure to the user.

8. A method of capturing an image of a scene with an image capture device, comprising:
receiving a user-initiated command to capture the image;
capturing the image of the scene;
in response to the user-initiated command to capture the image, analyzing the captured image for image artifacts; and
upon detection of an image artifact in the captured image, providing an alert to a user.

9. The method of claim 8, wherein the artifact comprises smear.

10. The method of claim 8, wherein the artifact comprises noise.

11. The method of claim 8, wherein the artifact comprises degraded focus.

12. The method of claim 8, wherein the artifact comprises degraded color or brightness.

13. The method of claim 8, wherein providing an alert to a user comprises providing an alert to the user of the type of artifact.

14. The method of claim 8, wherein providing an alert to a user comprises providing a suggested corrective measure.

15. An image capture device, comprising:
an image capture medium configured to record image data representative of a scene;
a lens, positioned to focus an image of the scene onto the image capture medium;
an input configured to receive a user-command to capture the image;
an output configured to alert a user to the presence of an image artifact in the captured image; and
a processor;
wherein the processor is programmed to:
receive at least a portion of the image data from the capture medium;
analyze the image data for the presence of the image artifacts; and
based on the analysis send alert information to the output.

16. The image capture device of claim 15, wherein the processor is further programmed to receive information from local contrast measurement circuitry and use the information to analyze the image data for the presence of image artifacts.

17. The image capture device of claim 15, wherein the processor is further programmed to receive motion estimation information from motion estimation circuitry and use the motion estimation information to analyze the image data for the presence of image artifacts.

18. The image capture device of claim 15, wherein image data comprises first image data and wherein the processor is further programmed to receive second image data from a contemporaneously captured image and use the second image data to analyze the first image data for the presence of image artifacts.

19. The image capture device of claim 15, wherein the processor is further programmed to determine whether automatic focused reached convergence at image capture and use the determination to analyze the image data for the presence of image artifacts.

20. The image capture device of claim 15, wherein the processor is further programmed to determine whether an automatic algorithm reached convergence at image capture and use the determination to analyze the image data for the presence of image artifacts.
